(19) United States
(12) Patent Application Publication
(10) Pub. No.: US 2009/0184950 A1
(43) Pub. Date: Jul. 23, 2009

(54) Power transmission circuit

(75) Inventors: Futoshi Furuta, Kokubunji (JP); Hiroshi Kageyama, Hachioji (JP); Ken Takei, Kawasaki (JP)

Correspondence Address: Stanley P. Fisher;Reed Smith LLP, Suite 1400, 3110 Fairview Park Drive, Fallls Church, VA, 22042-4503, US

(73) Assignee: Hitachi Displays, Ltd.

(21) Appl. No.: 12/320,191

(22) Filed: Jan. 21, 2009

(30) Foreign Application Priority Data
Jan. 21, 2008 (JP) 2008-010075

(51) Int. Cl. G09G 5/00

(52) U.S. Cl. 345/211

(57) ABSTRACT

Provided is a capacitor coupling type power transmission circuit in which a variation in receiving side voltage due to a variation in capacitance is suppressed to prevent an influence on a variation in load current in a display panel. An insulating board of the display panel is sandwiched by capacitive coupling electrodes formed on each of a transmitting side board and a board of the display panel, thereby forming capacitors. A non-contact transmission is performed by the capacitors. An alternating current voltage signal obtained by electrodes on a display panel side is rectified by a rectifier including diodes. A constant voltage circuit which is a shunt regulator including a diode array in which a resistor and a plurality of diodes are connected in series is provided to maintain a stabilized voltage irrespective of a variation in load in the display panel.

### CROSS-REFERENCE TO RELATED APPLICATION

The present application claims priority from Japanese application JP2008-010075 filed on Jan. 21, 2008, the content of which is hereby incorporated by reference into this application.

### BACKGROUND OF THE INVENTION

1. Field of the Invention

The present invention relates to a power transmission circuit for transmitting power from a board to another board in a non-contact manner, and is suitable for a circuit for transmitting power to a flat type display panel such as a liquid crystal display panel in an electrically non-contact manner.

2. Description of the Related Art

If power may be transmitted to a flat type display panel including a liquid crystal display panel in a non-contact manner without using a mechanical means such as a cable, a reduction in the number of parts such as wiring materials attached to the display panel, a reduction in mounting cost of the display panel, and a simplification of a manufacturing process may be expected. This contributes to the expansion of application fields of the display panel.

For example, in a case of a display apparatus using an active matrix display panel including thin film transistors (TFTs), power is supplied to the display panel from a circuit board on which a display control circuit is mounted through wiring parts such as a flexible printed cable. In contrast to this, a conventional technology for receiving power from an outside system through a non-contact transmission and supplying power to a display circuit and a display device such as the liquid crystal panel is described in JP 2005-301219 A. JP 2005-301219 A discloses systems for power supply through the non-contact transmission, for example, an electrostatic induction (capacitive coupling) system and a system based on electrostatic induction and an electromagnetic wave.

### SUMMARY OF THE INVENTION

When the electromagnetic wave or the electromagnetic induction is used for the non-contact transmission, a high-frequency carrier wave is necessary. Therefore, a rectifying device located on a display panel side is required to have high performance (response speed), and hence it is difficult to realize such a system by TFTs provided in the display panel. In a case of the electromagnetic induction, it is necessary to form a resonant coil and a resonant capacitor on the display panel, which causes an increase in area.

On the other hand, the capacitive coupling system may be constructed using only transmission electrodes, and hence the area may be reduced. However, because of a variation in capacitance between the transmitting and receiving sides, it is likely to vary a voltage generated on the receiving side. In addition, it is likely to influence the voltage by a variation in load current in the display panel, and hence a practical use is difficult.

An object of the present invention is to provide a capacitor coupling type power transmission circuit in which a variation in receiving side voltage due to a variation in coupling capacitance (electrostatic capacitance) is suppressed to prevent an influence on a variation in load current in a display panel.

In order to achieve the above-mentioned object, according to the present invention, an insulating layer (insulating board) of a display panel is sandwiched by capacitive coupling electrodes formed on each of a transmitting side board and a board of the display panel, thereby forming capacitors which perform a non-contact transmission. An alternating current voltage signal obtained by electrodes on a display panel side is rectified by a rectifier including diodes. A shunt regulator including a diode array in which a resistor and a plurality of diodes are connected in series is provided to maintain a stabilized voltage irrespective of a variation in load in the display panel.

An impedance between the power supply and the load generated by capacitive coupling (electrostatic capacitance) is normally a value which cannot be neglected as compared with a variation in the load impedance. A load voltage also varies depending on the variation in load impedance. When a constant voltage circuit which is the shunt regulator is inserted at a subsequent stage of the rectifier, the variation in load voltage is suppressed. When inductors are inserted in series with capacitors (capacitances) serving as capacitive coupling to construct resonant circuits, thereby setting a frequency of an alternating current power signal to a vicinity of a resonance frequency, the impedance between the power supply and the load is reduced.

When a full-wave rectification circuit (diode bridge) is applied as a circuit for rectifying an alternating current signal transmitted through the capacitors, the capacitors may be prevented from being charged up. When a voltage doubler rectifier is applied as the rectifier, a necessary power supply voltage may be reduced by half. When an alternating current signal transmitted through capacitive coupling and an alternating current signal transmitted through another system (such as electromagnetic coupling) are combined through respective diode bridges, a system in which a higher voltage is obtained is automatically selected. When a diode made of low-temperature polysilicon is directly formed on a board, a circuit required to supply power may be realized using only elements integrally formed on the display panel, without preparing a separate semiconductor chip.

### BRIEF DESCRIPTION OF THE DRAWINGS

In the accompanying drawings:

FIG. 1 is a developed explanatory perspective view illustrating a structure of a display panel according to Embodiment 1 of the present invention, to which a transmitting board for transmitting a display power signal through a non-contact transmission and a power transmission circuit for realizing reception are applied;

FIG. 2A is a circuit diagram illustrating a first example related to a rectifier and a constant voltage circuit according to Embodiment 1 of the present invention;

FIG. 2B is an explanatory diagram illustrating an operation of the circuits of FIG. 2A;

FIG. 2C is another explanatory diagram illustrating the operation of the circuits of FIG. 2A;

FIG. 3 is an explanatory diagram illustrating results obtained by numerical calculation of a load current-voltage characteristic in Embodiment 1 of the present invention;

FIG. 4A is a developed explanatory perspective view illustrating a structure of a power transmission in which coupling capacitors are connected in series with inductors, according to Embodiment 2 of the present invention;

FIG. 4B is an explanatory circuit diagram illustrating the structure of FIG. 4A;

FIG. 5 is an explanatory diagram illustrating results obtained by numerical calculation of a load current-voltage characteristic in Embodiment 2 of the present invention in a case where additional inductors are provided;

FIG. 6A is an explanatory diagram illustrating another principal structural example of an LC circuit according to Embodiment 2 of the present invention;

FIG. 6B is another explanatory diagram illustrating another principal structural example of the LC circuit according to Embodiment 2 of the present invention;

FIG. 6C is still another explanatory diagram illustrating another principal structural example of the LC circuit according to Embodiment 2 of the present invention;

FIG. 7A is an explanatory diagram illustrating a rectifier and a constant voltage circuit which are described in Embodiment 3 of the present invention;

FIG. 7B is an explanatory diagram illustrating an operation of the circuits of FIG. 7A;

FIG. 7C is another explanatory diagram illustrating the operation of the circuits of FIG. 7A;

FIG. 7D is an explanatory diagram illustrating the operation of the circuits of FIG. 7A;

FIG. 8 is an explanatory circuit diagram illustrating Embodiment 4 of the present invention, in which both a power transmission system based on capacitive coupling and a power transmission system based on electromagnetic induction are used; and

FIG. 9 is a developed explanatory perspective view illustrating a structure of a display panel according to Embodiment 5 of the present invention, to which a transmitting board for transmitting a display power signal through a non-contact transmission and a power transmission circuit for realizing reception are applied.

### DETAILED DESCRIPTION OF THE INVENTION

Hereinafter, a best mode of the present invention is described in detail with embodiments with reference to the attached drawings.

### Embodiment 1

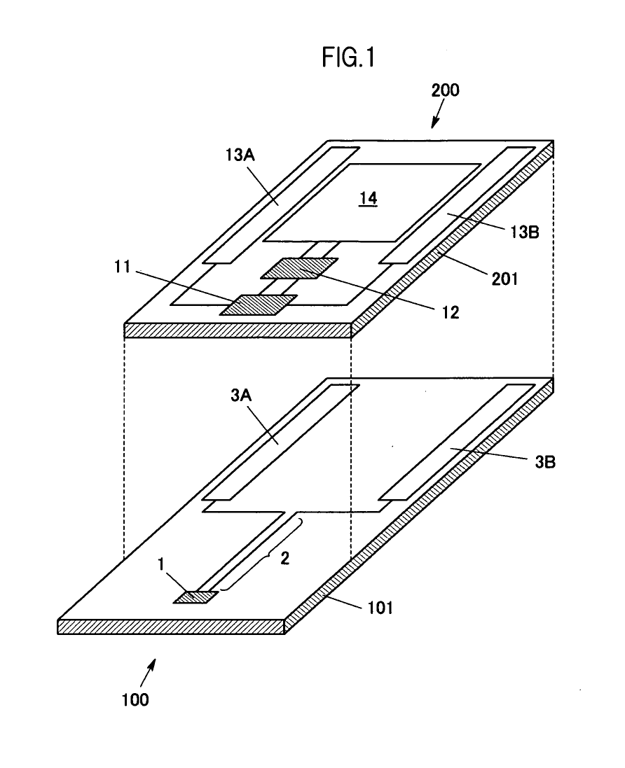

FIG. 1 is a developed explanatory perspective view illustrating a structure of a display panel according to Embodiment 1 of the present invention, to which a transmitting board for transmitting a display power signal through a non-contact transmission and a power receiving circuit for realizing reception are applied. A liquid crystal display panel including an active matrix board is assumed as an example of a power-supplied side. The display panel normally includes a panel circuit board on which circuit elements related to a display function are integrated, a panel opposite board, and a liquid crystal portion sandwiched between both the boards. In FIG. 1, the panel opposite board and the liquid crystal portion of the display panel are not illustrated, and the panel circuit board is illustrated as a receiving board 200. The receiving board 200 includes a display region in which a plurality of pixels are arranged in matrix and a display drive circuit, which are collectively denoted by reference numeral 14.

Respective constituent elements illustrated in FIG. 1 are described along the flow of signals. An alternating current signal generator 1, a balanced transmission line 2, and a pair of capacitive coupling electrodes 3A and 3B are formed on a surface (surface opposed to the receiving board 200) of an insulating board 101 (first insulating board) included in the transmitting board 100. In the transmitting board 100, power to be transmitted to the receiving board 200 serving as the display panel is generated as an alternating current signal by the alternating current signal generator 1, and transmitted to the pair of capacitive coupling electrodes 3A and 3B through the transmission line 2 located on the insulating board 101 included in the transmitting board 100. In FIG. 1, the transmission line is a balanced transmission line 2 including two signal lines as a pair, or may alternatively be an unbalanced transmission line such as a microstrip line. When a distance between the alternating current signal generator 1 and the capacitive coupling electrodes 3A and 3B is sufficiently shorter than a wavelength of a maximum frequency component of a transmitted alternating current signal, a specified transmission line is not necessarily provided.

The display region and display drive circuit 14 and a pair of capacitive coupling electrodes 13A and 13B are formed on a surface (surface opposite to transmitting board) of an insulating board 201 (second insulating board) included in the receiving board 200. The capacitive coupling electrodes 3A and 3B located on the insulating board 101 included in the transmitting board 100 are arranged to be opposed to the capacitive coupling electrodes 13A and 13B located on the insulating board (second insulating board) 201 included in the receiving board 200, respectively. With this structure, the second insulating board 201 is interposed between the capacitive coupling electrodes 3A and 3B and the capacitive coupling electrodes 13A and 13B, thereby constructing a pair of capacitors. The second insulating board 201 is made of an insulating material such as glass or plastic.

An alternating current voltage induced by the capacitive coupling electrodes 13A and 13B located on the receiving board 200 side serving as the display panel is immediately input to a rectifier 11 and converted into a pulsating signal. After that, the pulsating signal is input to a constant voltage circuit 12 and stabilized. Then, the stabilized signal is supplied to the display region and display drive circuit 14 serving as a load.

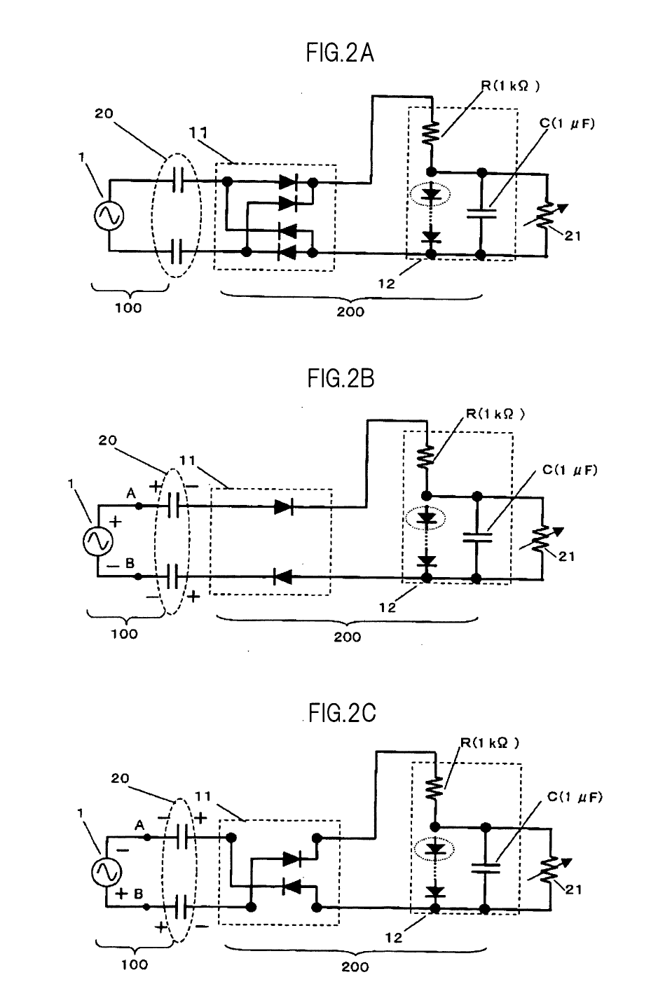

FIG. 2A is a circuit diagram illustrating a first example related to the rectifier 11 and the constant voltage circuit 12 according to Embodiment 1 of the present invention. FIGS. 2B and 2C are explanatory diagrams illustrating an operation of the circuits of FIG. 2A. As illustrated in FIG. 2A, a full-wave rectification system using a diode bridge is employed for the rectifier 11 of this embodiment. When the alternating current signal transmitted from the alternating current signal generator 1 through a capacitive coupling 20 including the capacitors is to be rectified, it is necessary to reliably perform a charging and discharging operation of the capacitors by alternating of the alternating current signal. Therefore, the full-wave rectification system based on a full period, that is the alternating voltage, is more suitable than a single-wave rectification system based on a half period of the alternating current signal. For example, as illustrated in FIG. 2B, when a terminal A is higher in electric potential than a terminal B, the respective coupling capacitors are charged as illustrated in this figure. As illustrated in FIG. 2C, when the terminal A is lower in electric potential than the terminal B, charges of the capacitors are forcedly discharged and then charged with reverse polarities. During the charging and discharging process, a current flows into the rectifier 11, with the result that a pulsating current is output.

The rectified pulsating current signal is stabilized by the constant voltage circuit 12. In this embodiment, the constant voltage circuit 12 is constructed with a shunt system. This circuit includes a series resistor R (for example, 1 kΩ), series-connected diodes for determining an output voltage, and a capacitor C (for example, 1 μF).

A feature of such a shunt-type regulator is not to have a specified feedback loop or an error amplifier explicitly, in order to stabilize the voltage. The advantages are that a very small circuit scale may be designed and that the regulator may be realized even when circuit elements difficult to form the error amplifier (low-temperature polysilicon thin film transistor in display panel) are used. On the other hand, the disadvantage is that, when the load has large power consumption, a power loss of the constant voltage circuit itself becomes larger, with the result that it is difficult to stabilize the output voltage. When the regulator is applied to a low-power consumption device such as the liquid crystal display panel as in this embodiment, the disadvantage does not become a problem.

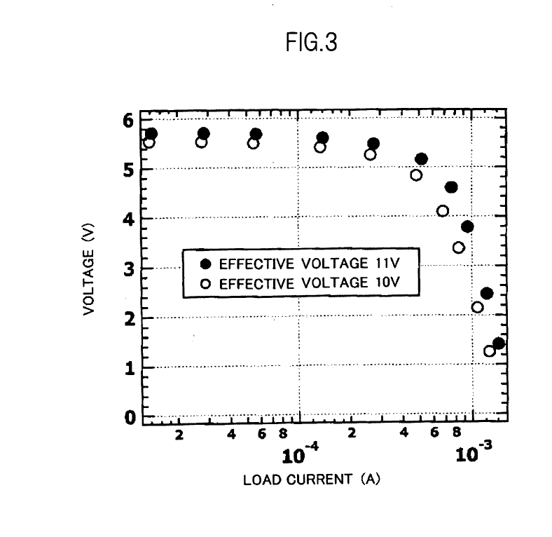

FIG. 3 is an explanatory diagram illustrating results obtained by numerical calculation of a load current-voltage characteristic in Embodiment 1 of the present invention. FIG. 3 illustrates a load current-voltage characteristic in a case where the rectifier 11 and the constant voltage circuit 12 are constructed using a coupling capacitor of 10 pF and a diode including low-temperature polysilicon thin film transistors (LTPS-TFTs). The constant voltage circuit 12 is assumed to include four diodes connected in series. A variation range of a load current is 40 μA to 400 μA in consideration of the power consumption of the liquid crystal display panel. An alternating current signal to be supplied is a sinusoidal wave and a frequency thereof is 13.56 MHz. As is apparent from FIG. 3, when an effective voltage of the sinusoidal wave is 10 V, a voltage is within approximately 5V in an assumed load current range.

### Embodiment 2

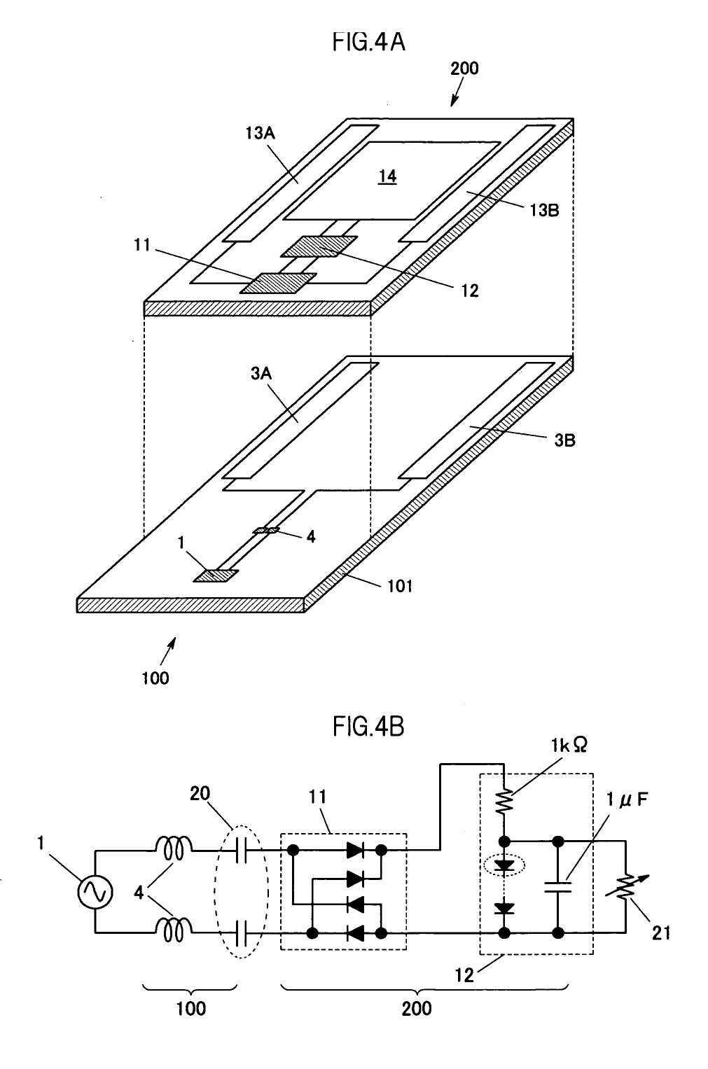

FIG. 4A is a developed explanatory perspective view illustrating a structure of a power transmission in which coupling capacitors are connected in series with inductors, according to Embodiment 2 of the present invention. FIG. 4B is an explanatory circuit diagram illustrating the structure of FIG. 4A. As in Embodiment 1, the liquid crystal display panel is described as an example. A series resonant circuit comprises each of the coupling capacitors which configure a capacitive coupling 20 and corresponding each of inductors 4 connected in series with the coupling capacitors. When the alternating current signal is transmitted at a resonance frequency, an alternating current impedance at the capacitive coupling 20 may be reduced. In FIG. 4B, the remaining structure is identical to that of the circuit illustrated in FIG. 2A.

Specifically, when an additional inductance (one side) is expressed by L and a coupling capacitance (same side) is expressed by C, a resonance frequency f is expressed by the following expression.

f=1/(2π√(LC))

For example, when an alternating current frequency is 13.56 MHz and a coupling capacitance is 10 pF, an inductance obtained by the expression described above is 13.4 μH.

FIG. 5 is an explanatory diagram illustrating results obtained by numerical calculation of a load current-voltage characteristic in Embodiment 2 of the present invention in a case where the additional inductors are provided. As is apparent from FIG. 5, an effective voltage required to stabilize the load voltage is reduced from 11 V to 9 V as compared with the case where the additional inductors 4 are not provided. The supplied voltage may be reduced without a reduction in power consumption of the load 21, and hence power transmission efficiency is improved.

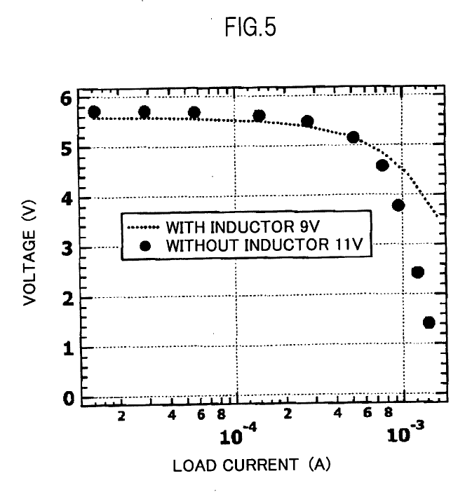

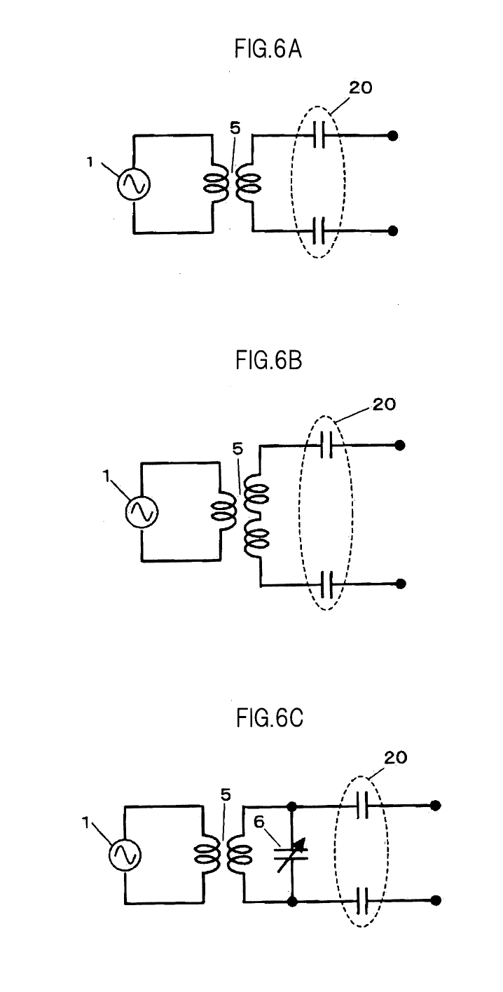

FIGS. 6A, 6B, and 6C are explanatory diagrams illustrating other principal structural examples of an LC circuit according to Embodiment 2 of the present invention. Each of FIGS. 6A, 6B, and 6C illustrates that the alternating current signal generator 1 and the capacitive coupling 20 are electromagnetically coupled with each other through a transformer 5. In FIG. 6A, the winding number of coil on the alternating current signal generator 1 side is equal to that on the capacitive coupling 20 side. In FIG. 6B, the winding number of coil on the capacitive coupling 20 side is set to a value larger than that on the alternating current signal generator 1 side to increase a voltage induced on the capacitive coupling 20 side. In FIG. 6C, a capacitor 6 is provided on the capacitive coupling 20 side to construct a resonant circuit, thereby increasing the amplitude of an alternating current signal to transmit a high voltage to the display panel. The capacitor 6 may be used as a variable capacitor to adjust a resonance frequency. The resonant circuit is equivalent to a resonant circuit used for the electromagnetic induction system as described in the known example. However, in Embodiment 2, all the inductors are mounted outside the display panel, that is, on the transmitting board side. Therefore, only the capacitor is desirably integrated on the display panel as in Embodiment 1 and thus the area of the receiving circuit does not expand.

### Embodiment 3

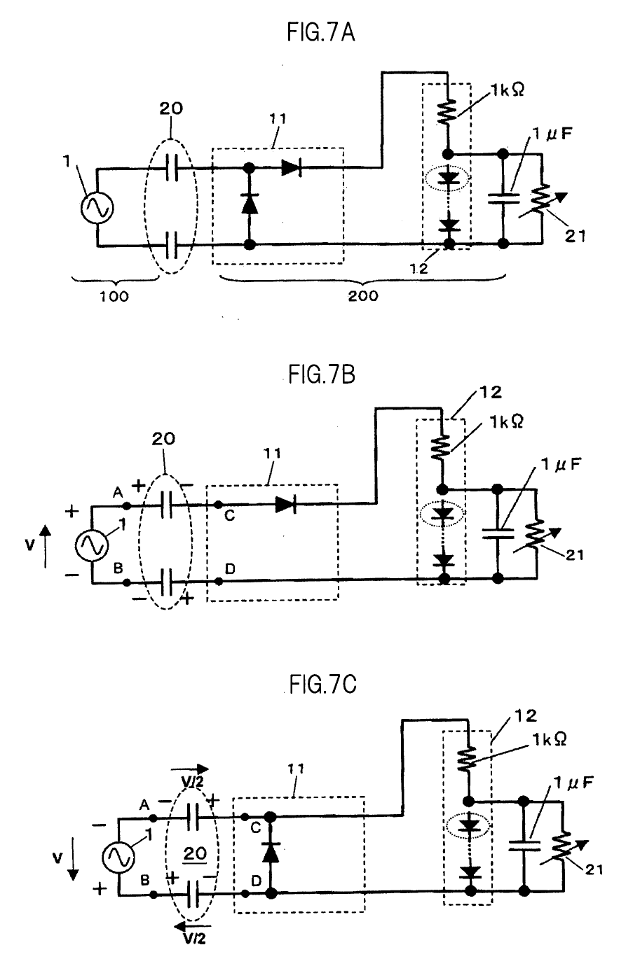

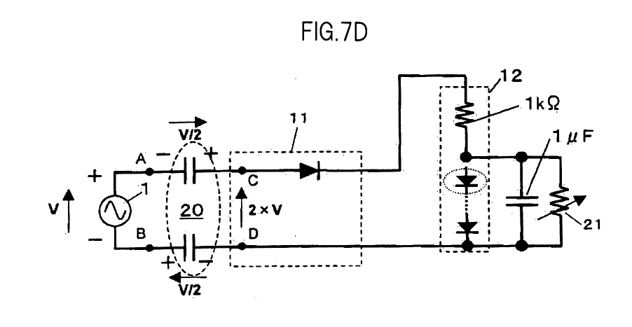

FIG. 7A is an explanatory diagram illustrating the rectifier 11 and the constant voltage circuit 12 which are described in Embodiment 3 of the present invention. The rectifier described in Embodiment 1 is constructed with a double voltage rectification system (voltage doubler rectifier).

FIGS. 7B, 7C, and 7D are explanatory diagrams illustrating an operation of the circuits of FIG. 7A. The advantage of the circuit according to Embodiment 3 is that power may be transmitted at a half alternating current voltage (effective voltage) as compared with Embodiment 1. The operation of the circuits illustrated in FIG. 7A is described with reference to FIGS. 7B to 7D. As illustrated in FIG. 7B, when the terminal A is higher in electric potential than the terminal B, the coupling capacitors of the capacitive coupling 20 are charged with charges of signs illustrated in FIG. 7B as in Embodiment 1. Then, when the terminal A is lower in electric potential than the terminal B, a current does not flow into the shunt regulator 12 side of the display panel 200, the charges of the capacitors are discharged, and the respective coupling capacitors are charged as illustrated in FIG. 7C. Then, when the electric potential at the terminal A becomes higher, as illustrated in FIG. 7D, electrode potentials of the respective capacitors become equal in direction to potentials of a power supply, and hence a potential between terminals C and D at a preceding stage of the rectifier 11 becomes approximately two times a power supply voltage. After that, when the respective capacitors are discharged, the circuits according to Embodiment 3 returns to the state illustrated in FIG. 7A.

Unlike the full-wave rectification system described in Embodiment 1, according to the double voltage rectification system in this embodiment, while the terminal A is lower in electric potential than the terminal B, a current does not flow into the shunt regulator 12. Therefore, this method is effective in the case where the load current is low.

### Embodiment 4

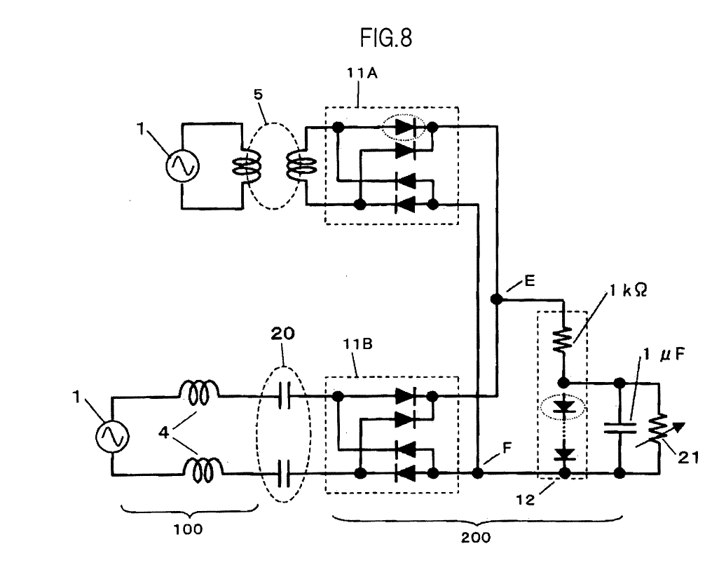

FIG. 8 is an explanatory circuit diagram illustrating Embodiment 4 of the present invention, in which both the power transmission system based on capacitive coupling and the power transmission system based on electromagnetic induction are used. The capacitors of the capacitive coupling 20 and an induction coil of an electromagnetic coupling 5 are connected with the respective rectifiers 11. Outputs of the respective rectifiers are connected in parallel with the constant voltage circuit (shunt regulator) 12. An alternating current signal transmitted from the alternating current signal generator 1 through any one of the capacitive coupling 20 and the induction coil of the electromagnetic coupling 5 is converted into a pulsating current through corresponding one of the rectifiers, and stabilized by the shunt regulator 12.

When alternating current signals are transmitted from both the capacitors of the capacitive coupling 20 and the induction coil of the electromagnetic coupling 5, a system capable of generating a higher voltage between terminals E and F as an input voltage of the shunt regulator 12 is automatically selected. For example, when a higher voltage is obtained in the capacitive coupling system, an alternating current signal passes through the rectifier “11 B” located on the capacitor side. A voltage induced between the terminals E and F (instantaneous value and forward direction voltage drop component of diode are subtracted) becomes higher than a voltage induced in the induction coil (instantaneous value and forward direction voltage drop component of diode are subtracted), and hence the rectifier “11 A” provided on the induction coil side is turned off because of the action of diodes of the rectifier. According to Embodiment 4, the power supply means for the display panel is automatically selected, whereby the display panel may be constantly operated even when the display panel is moved.

### Embodiment 5

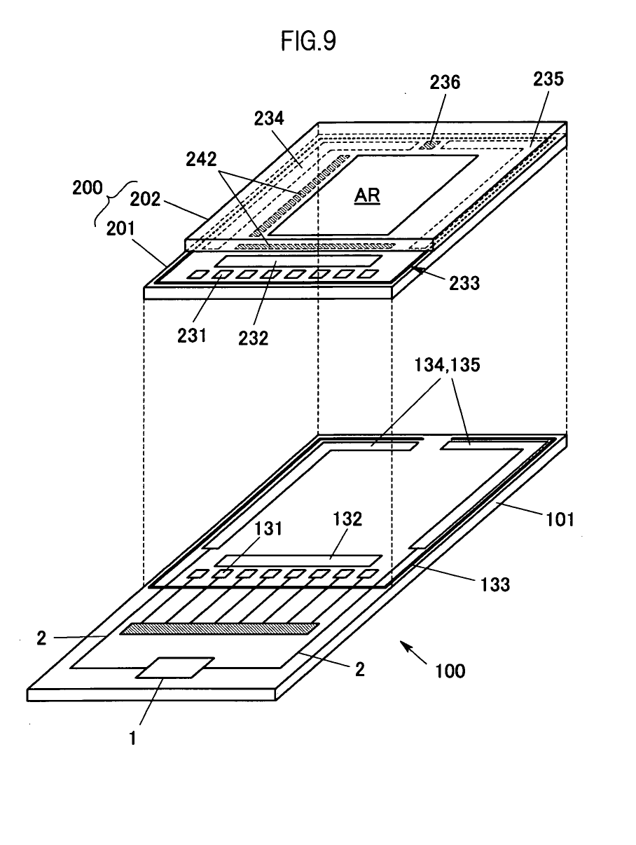

FIG. 9 is a developed explanatory perspective view illustrating a structure of a display panel according to Embodiment 5 of the present invention, to which a transmitting board for transmitting a display power signal through a non-contact transmission and a power transmission circuit for realizing reception are applied. In FIG. 9, the alternating current signal generator 1, the balanced transmission line 2, and a pair of power transmitting side capacitive coupling electrodes 134 and 135, which are the same as those of described in Embodiment 1, are provided on the first insulating board 101 included in the transmitting board 100. In addition to those, a video signal processing circuit 130, signal transmitting side capacitive coupling electrodes 131, and a transmitting side common potential capacitive coupling electrode 132 are provided. In Embodiment 5, a power transmitting coil 133 for electromagnetically transmitting power is further provided. An alternating current signal generator for applying alternating current power to the power transmitting coil 133 is not particularly illustrated. The alternating current signal generator may be provided in an appropriate space on a surface of the transmitting board 100 or a rear surface thereof. The same holds in the case of the alternating current signal generator 1.

In Embodiment 5, the display panel to which the power is supplied is the liquid crystal display panel, and the receiving board 201 opposed to the transmitting board 100 is the active matrix board of the liquid crystal display panel 200. Power receiving side capacitive coupling electrodes 234 and 235 paired respectively with the capacitive coupling electrodes 134 and 135 located on the transmitting board 100 side, a rectifier, and a constant voltage circuit 236 are provided on the receiving board 201. The structure and operation of the power transmission circuit are identical to those of Embodiment 1. The circuit described in each of Embodiments 2 to 4 may be applied to this embodiment in the same manner.

Signal receiving side capacitive coupling electrodes 231, a receiving side common potential capacitive coupling electrode 232, a display portion AR in which a plurality of pixel elements are arranged in matrix, and drive circuits 242 for driving the pixels are further provided on the receiving board 201. A power receiving coil 233 electromagnetically coupled with the power transmitting coil 133 to receive power is also provided. When power signals are input to the power transmitting side capacitive coupling electrodes and the power transmitting coil, any one of the capacitive coupling and the electromagnetic coupling is selected as the power transmission system by the same method as in Embodiment 4. When power is supposed to be transmitted through the capacitive coupling, the power transmitting and receiving structure based on the electromagnetic coupling is not essential.

The liquid crystal display panel 200 has the structure in which the receiving board 201 and the opposite board 202 are bonded to each other so as to sandwich a liquid crystal portion (not illustrated). A color filter, a black matrix, and an opposite electrode (in case of TN system) are formed over an inner surface of the opposite board 202. As described above, in Embodiment 5, when both the power transmission system and the system for transmitting display signals to the display portion of the display panel are provided based on capacitive coupling (and electromagnetic coupling), connection wiring for transmitting not only power but also display signals are unnecessary.

While there have been described what are at present considered to be certain embodiments of the invention, it will be understood that various modifications may be made thereto, and it is intended that the appended claims cover all such modifications as fall within the true spirit and scope of the invention.

1. A power transmission circuit for transmitting power from a transmitting board side to a receiving board side in an non-contact manner, comprising:
a transmitting board including a first insulating board, on which an alternating current power signal generator and transmitting side capacitive coupling electrodes connected with an output of the alternating current power signal generator are provided; and
a receiving board including a second insulating board, on which receiving side capacitive coupling electrodes, a rectifier, a constant voltage circuit, and a load are provided,
wherein the transmitting side capacitive coupling electrodes and the receiving side capacitive coupling electrodes serve as a pair of capacitors in which the transmitting side capacitive coupling electrodes and the receiving side capacitive coupling electrodes are stacked through an insulating layer, and
Wherein the rectifier rectifies an electric current from the pair of capacitors, and the rectified electric current is sequentially inputted to the constant voltage circuit and the load.

2. A power transmission circuit according to claim 1, wherein the receiving board is an active matrix board which includes a plurality of pixels two-dimensionally arranged and a display drive circuit for driving the plurality of pixels, and which serves as a flat display panel.

3. A power transmission circuit according to claim 1, wherein the insulating layer serving as each of the pair of capacitors is at least one of the first insulating board and the second insulating board.

4. A power transmission circuit according to claim 1, wherein the rectifier comprises a bridge circuit including four diodes connected with outputs of the receiving side capacitive coupling electrodes.

5. A power transmission circuit according to claim 1, wherein the rectifier comprises a voltage doubler rectifier including two diodes connected with outputs of the receiving side capacitive coupling electrodes.

6. A power transmission circuit according to claim 1, wherein the constant voltage circuit is a shunt regulator including a diode array in which a resistor and a plurality of diodes are connected in series.

7. A power transmission circuit according to claim 1, further comprising:
an inductor inserted in series between the alternating current power signal generator and each of the transmitting side capacitive coupling electrodes; and
wherein the inductor and each of the pair of capacitors forms a resonant circuit.

8. A power transmission circuit according to claim 1, further comprising:
a transmitting side electromagnetic induction coil provided on the first insulating board; and
a receiving side electromagnetic induction coil induction-coupled with the transmitting side electromagnetic induction coil is provided on the second insulating board,
wherein the receiving side electromagnetic induction coil is connected to the constant voltage circuit through a second rectifier.
